(19) United States
(12) Patent Application Publication
(10) Pub. No.: US 2012/0259480 A1
(43) Pub. Date: Oct. 11, 2012

(54) VEHICLE-MOUNTED DEVICE, METHOD FOR ACTIVATING THE VEHICLE-MOUNTED DEVICE AND VEHICLE-MOUNTED SYSTEM

(75) Inventors: Liang Huo, Shanghai (CN); Zhifeng Zhong, Shanghai (CN); Yu Yao, Shanghai (CN); Jun Zhu, Shanghai (CN); Jianlong Luo, Shanghai (CN); Dawei Zhu, Shanghai (CN); Yehui Zhang, Shanghai (CN)

(73) Assignees: Shanghai PATEO Internet Technology Service Co., Ltd., Shanghai (CN); Shanghai PATEO Electronic Equipment Manufacturing Co., Ltd., Shanghai (CN)

(21) Appl. No.: 13/392,009

(22) PCT Filed: Dec. 27, 2010
(86) PCT No.: PCT/CN10/80313

§ 371 Date: Feb. 23, 2012

(30) Foreign Application Priority Data
Dec. 31, 2009 (CN) 200910247978.7

(51) Int. Cl. G06F 7/00

(52) U.S. Cl. 701/2; 701/1

(57) ABSTRACT

The present invention provides a vehicle-mounted device, a method for activating the vehicle-mounted device, and a vehicle-mounted system. The vehicle-mounted system includes a vehicle-mounted device, a data center, and a service platform. The vehicle-mounted device not only can be locally activated according to an activating information corresponding to an identity information of the vehicle-mounted device which indicates an unique identity of the vehicle-mounted device, but also can be remotely activated through wireless communication. Moreover, the vehicle-mounted system further includes application sub-modules which can provide extended/added functions. Therefore, by the method for activating a vehicle-mounted device provided by the present invention, the vehicle-mounted device can be activated in time, so that the information resources can be more easily and conveniently obtained by the user.

### CROSS REFERENCE TO RELATED APPLICATIONS

The present application claims the priority of Chinese Patent Application No. 200910247978.7, entitled “Vehicle-mounted Device, Method for Activating the Vehicle-mounted Device and Vehicle-mounted System”, and filed on Dec. 31, 2009, the entire disclosure of which is incorporated herein by reference.

### FIELD OF THE INVENTION

The present invention generally relates to a vehicle-mounted device, a method for activating the vehicle-mounted device and a vehicle-mounted system, and more particularly, to a vehicle-mounted device which can perform wireless communication, a method for activating the vehicle-mounted device and a vehicle-mount system.

### BACKGROUND OF THE INVENTION

With economic development and social progress, automobiles become a popular consumer product, more and more consumers buy the automobiles and requirements of the consumers get higher and higher. Recently, besides economy and mobility, functional diversification and operation simplification also become important factors for attracting the consumers. In order to meet the requirements of the consumers, vehicle-mounted devices with functions such as playing music and showing e-books are already applied in the automobiles. However, the vehicle-mounted devices can not send data like computers, if information resources like music, E-books are needed, such resources can only be obtained by buying a video compact disc (VCD), or a compact disc (CD), or downloading such resources by a PC and then storing them to a vehicle-mounted device, which is complex and inconvenient for the consumers.

Furthermore, when an owner or an agent authorized by the owner of a vehicle fetches an automobile, the vehicle-mounted device may be used immediately. However, it is difficult to control whether to activate the vehicle-mounted device and to effectively control the using process while using functions of the vehicle-mounted device.

In prior art, an upgrading device of a vehicle-mounted electronic device, a vehicle-mounted electronic system, and an automobile are disclosed, which enable a user to upgrade the vehicle-mounted electronic device with the upgrading device. However, in the prior art, many devices and complex operations are needed, which brings inconvenience to the user.

### SUMMARY OF THE INVENTION

In order to solve the above problems in the prior art, embodiments of the present invention provide a vehicle-mounted device, a method for activating the vehicle-mounted device and a vehicle-mounted system.

The embodiments of the present invention provide a method for locally activating a vehicle-mounted device of an automobile, including:

Receiving an activating information after an activating process is triggered; and

Verifying the received activating information according to a comparison information locally prestored in the vehicle-mounted device, wherein the vehicle-mounted device is configured in an activated state if the verification is successful.

Optionally, the activating process is triggered when the automobile or the vehicle-mounted device is started, or when an activating operation is received from a user.

Optionally, the vehicle-mounted device receives the activating information from an interface which is used for acquiring the activating information and provided by the vehicle-mounted device.

Optionally, the activating information is corresponding to an identity information of the vehicle-mounted device.

Optionally, the activating information includes a self-checking bit which is used, with a verifying algorithm stored in the vehicle-mounted device, to verify the activating information.

The embodiments of the present invention further provide a vehicle-mounted device of an automobile, including:

An input device, adapted for receiving information, wherein the information includes an activating information; and

A processing device, adapted for processing the received information, verifying the activating information and configuring the vehicle-mounted device in an activated state if the verification is successful.

Optionally, the processing device includes:

An activating information acquiring unit, adapted for acquiring the activating information from the input device when an activating process is triggered; and

An activating information processing unit, adapted for verifying the activating information and configuring the vehicle-mounted device in an activated state if the verification is successful.

Optionally, the vehicle-mounted device further includes: a triggering signal processing device, adapted for triggering the activating process when the automobile or the vehicle-mounted device is started, or an activating operation is received from a user.

Optionally, the vehicle-mounted device further includes: an automatic starting device, adapted for automatically starting the vehicle-mounted device when the automobile is started.

The embodiments of the present invention further provide a method for remotely activating a vehicle-mounted device of an automobile, including:

Receiving an activating information;

Sending the received activating information from a service platform to a data center;

Verifying the activating information by the data center according to a comparison information prestored in the data center and providing a feedback information for activating the vehicle-mounted device if the verification is successful; and

Sending the feedback information to the vehicle-mounted device through the service platform.

Optionally, the activating process is trigged when the automobile or the vehicle-mounted device is started, or when an activating operation is received from a user.

Optionally, the vehicle-mounted device receives the activating information from an interface which is used for acquiring the activating information and provided by the vehicle-mounted device.

Optionally, the activating information is corresponding to an identity information of the vehicle-mounted device.

Optionally, the activating information includes an account and a password which are created previously.

Optionally, the account and the password, created previously as the activating information, have a corresponding relationship with the identity information of the vehicle-mounted device.

The embodiments of the present invention further provide a vehicle-mounted device of an automobile, including:

A communication device, adapted for data intercommunication between the vehicle-mounted device and a service platform;

An input device, adapted for receiving information, wherein the information includes an activating information; and

A processing device, adapted for processing the received information and sending out the activating information by the communication device.

Optionally, the processing device includes:

An activating information acquiring unit, adapted for acquiring the activating information from the input device when the activating process is triggered; and

An activating information processing unit, adapted for processing the activating information, sending out the activating information through the communication device, and configuring the vehicle-mounted device in an activated state according to an feedback information from the data center.

Optionally, the vehicle-mounted device further includes: a triggering signal processing device, adapted for triggering the activating process when the automobile or the vehicle-mounted device is started, or an activating operation is received from a user.

Optionally, the vehicle-mounted device further includes an automatic starting device, adapted for automatically starting the vehicle-mounted device when an automobile is started.

The embodiments of the present invention further provide a vehicle-mounted system of an automobile, including:

A vehicle-mounted device, a data center, and a service platform, wherein the platform is adapted for receiving an activating information from the vehicle-mounted device and sending the activating information to the data center, and wherein the data center includes a data storage unit and a data processing unit which is adapted for verifying the activating information according to a comparison information prestored in the data storage unit and providing an feedback information for activating the vehicle-mounted device.

Optionally, the vehicle-mounted device includes:

A communication device, adapted for data intercommunication between the vehicle-mounted device and a service platform;

An input device, adapted for receiving information, wherein the information includes an activating information; and

A processing device, adapted for processing the received information and sending out the activating information by the communication device.

Optionally, the processing device includes:

An activating information acquiring unit, adapted for acquiring the activating information from the input device when the activating process is triggered; and

An activating information processing unit, adapted for processing the activating information, sending out the activating information by the communication device, and configuring the vehicle-mounted device in an activated state according to the feedback information from the data center.

Optionally, the processing device further includes application subunits which are adopted to response service requirements from a user.

Optionally, the vehicle-mounted device further includes a triggering signal processing device, adapted for triggering the activating process when the automobile or the vehicle-mounted device is started, or an activating operation is received from a user.

According the vehicle-mounted device, the method for activating the vehicle-mounted device and the vehicle-mounted system which are provided by the embodiments of the present invention, the vehicle-mounted device can be activated in any region covered with wireless networks, which is convenient and easy to operate. The unique identity of the vehicle-mounted device can be realized, which can ensure individual privacy of the user.

### BRIEF DESCRIPTION OF THE DRAWINGS

FIG. 1 is a schematic flow chart for illustrating a method for locally activating a vehicle-mounted device in a first embodiment of the present invention;

FIG. 2 is a schematic view illustrating a structure of a vehicle-mounted device according to the first embodiment of the present invention;

FIG. 3 is a schematic view illustrating a structure of a processing device of a vehicle-mounted device according to the first embodiment of the present invention;

FIG. 4 is a flow chart illustrating a method for remotely activating a vehicle-mounted device in a second embodiment of the present invention;

FIG. 5 is a schematic view illustrating a structure of a vehicle-mounted device according to the second embodiment of the present invention;

FIG. 6 is a schematic view illustrating a structure of a processing device of a vehicle-mounted device according to the second embodiment of the present invention;

FIG. 7 is a schematic view illustrating a structure of a vehicle-mounted system according to the second embodiment of the present invention; and

FIG. 8 is a schematic view illustrating major units of a vehicle-mounted system according to the second embodiment of the present invention.

### DETAILED DESCRIPTION OF THE EMBODIMENTS

In a first embodiment of the present invention, a method for locally activating a vehicle-mounted device of an automobile is provided, and the method includes: Receiving an activating information after an activating process is triggered; and verifying the received activating information according to a comparison information locally prestored in the vehicle-mounted device, wherein if the verification is successful, the vehicle-mounted device is configured in an activated state. In the first embodiment, the activating process is trigged when the automobile or the vehicle-mounted device is started, or when an activating operation is received from a user. The vehicle-mounted device receives the activating information through an interface which is used for acquiring the activating information and provided by the vehicle-mounted device. In an example embodiment, the activating information is corresponding to an identity information of the vehicle-mounted device which identifies an unique identity of the vehicle-mounted device. In another example embodiment, the activating information includes a self-checking bit which is used, with a verifying algorithm prestored in the vehicle-mounted device, to verify the activating information.

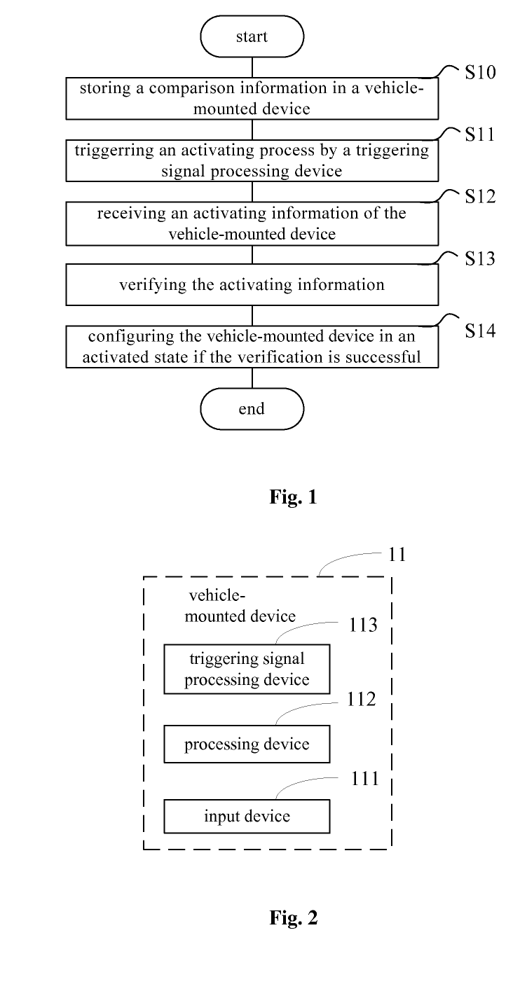

FIG. 1 is a schematic flow chart for illustrating a method for locally activating a vehicle-mounted device of an automobile in the first embodiment. In the first embodiment, a method for locally activating a vehicle-mounted device of an automobile is illustrated by taking it for an example that there is a corresponding relationship between the activating information and the identity information of the vehicle-mounted device. In addition, to make it clear, the activating information is labeled as C11, and the corresponding comparison information for verifying the activating information is labeled as C12.

Referring to FIG. 1, the method for locally activating the vehicle-mounted device of the automobile in the first embodiment will be described in detail hereinafter.

A step S10 is performed, in which the comparison information C12 is stored in the vehicle-mounted device. The comparison information C12 may be the same as the activating information C11, or may be an information which has a certain corresponding relationship with the activating information Cl 1. In an example embodiment, the step S10 may be performed in a production process of the automobile by an automobile producer or in a sale process by a dealer.

A step S11 is performed, in which an activating process is triggered by a triggering signal processing device. In an embodiment, the activating process is started by the triggering signal processing device when the automobile or the vehicle-mounted device is started, or when an activating operation is received from a user. In an embodiment, the vehicle-mounted device may automatically provide an interface for acquiring activating information if the automobile is started.

A step S12 is performed, in which the activating information C11 is received. The activating information C11 is corresponding to the identity information of the vehicle-mounted device, which indicates an unique identity of the vehicle-mounted device. In an embodiment, the identity information may include serial numbers of the vehicle-mounted device. The vehicle-mounted device receives the activating information C11 through the interface for acquiring activating information.

A step S13 is performed for verifying the received activating information in the vehicle-mounted device. In the step S13, the received activating information C11 is verified according to the locally prestored comparison information C12.

A step S14 is performed for configuring the vehicle-mounted device in an activated state if the verification is successful. After being activated, the vehicle-mounted device may respond to service requirements of the user such as downloading music, pictures, and videos.

It should be noted that, in another embodiment, the activating information includes a self-checking bit stored in the vehicle-mounted device, which is used to verify with a verifying algorithm, which is similar to the embodiment that there is a corresponding relationship between the activating information and the identity information which indicates the unique identity of the vehicle-mounted device, and will not described in detail herein.

The first embodiment of the present invention further provides a vehicle-mounted device, and the vehicle-mounted device includes: An input device which is adapted for receiving information, wherein the information includes an activating information; and a processing device which is adapted for processing the received information, such as verifying the activating information and configuring the vehicle-mounted device in an activated state if the verification is successful. The processing device includes: An activating information acquiring unit adapted for acquiring the activating information from the input device when the activating process is triggered; and an activating information processing unit adapted for verifying the activating information and configuring the vehicle-mounted device in the activated state if the verification is successful. In an embodiment, the vehicle-mounted device further includes a triggering signal processing device and an automatic starting device which is adapted for automatically starting the vehicle-mounted device when the automobile is started. The triggering signal processing device is adapted for triggering the activating process when the automobile or the vehicle-mounted device is started, or an activating operation is received from a user.

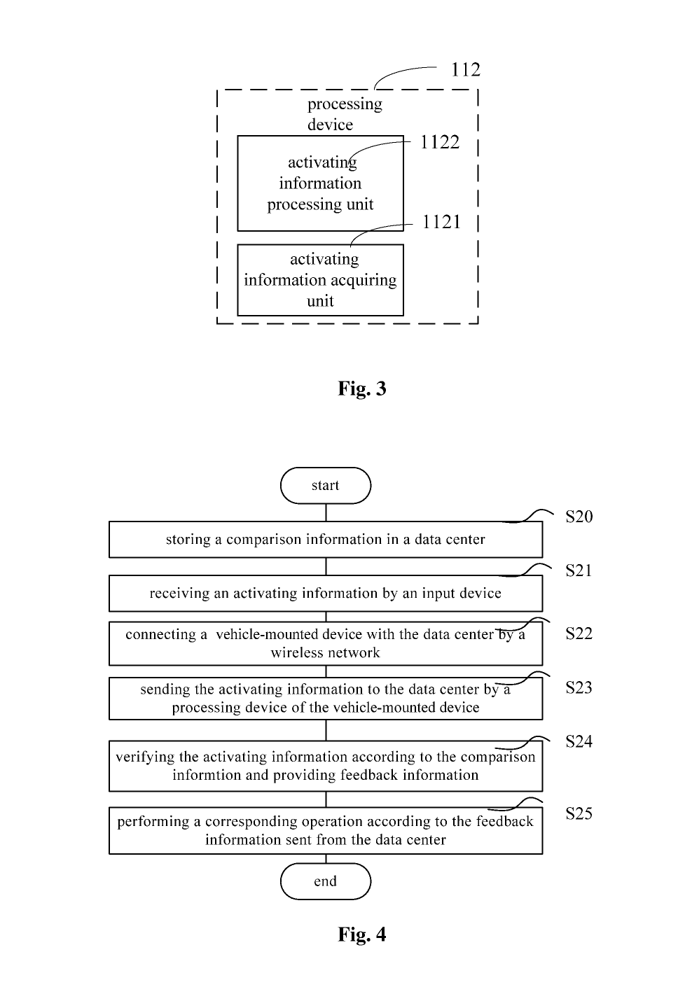

FIG. 2 is a schematic view illustrating a structure of a vehicle-mounted device in the first embodiment, and FIG. 3 is a schematic view illustrating a structure of a processing device of a vehicle-mounted device in the first embodiment. The vehicle-mounted device provided in the first embodiment will be described in detail hereinafter in conjunction with FIG. 2 and FIG. 3.

Referring to FIG. 2, in the first embodiment, the vehicle-mounted device of the automobile includes: An input device 111, adapted for inputting information which includes an activating information of the vehicle-mounted device; and a processing device 112, adapted for processing the received information, such as verifying the activating information input through the input device 111 and configuring the vehicle-mounted device in an activated state if the verification is successful; and a triggering signal processing device 113, adapted for triggering the activating process according to the start information of the automobile or the vehicle-mounted device or according to the activating operation information of the user when the automobile or the vehicle-mounted device is started, or an activating operation is received from an user. In addition, the vehicle-mounted device further includes a displaying device with displaying function (not shown in the drawings).

In an embodiment, a touch-screen display with both functions of inputting and displaying is used as the input device 111, which can not only be used to input operation information of the user, but also be used to play music and display e-books. Referring to FIG. 3, the processing device 112 includes: An activating information acquiring unit 1121 which is adapted for acquiring the activating information from the input device when the activating process is triggered; and an activating information processing unit 1122 which is adapted for verifying the activating information and configure the vehicle-mounted device in the activated state if the verification is successful. Because the processing device 112 has functions such as verifying the activating information, configuring the vehicle-mounted device in the activated state if the verifying process is successful, the processing device 112 is preferably configured to be a device with a reliable processing performance and a fast processing speed.

Furthermore, the vehicle-mounted device further includes an automatic starting device which is adapted for automatically starting the vehicle-mounted device when the automobile is started. The processing unit further includes application subunits which are adapted for responding to the requirement of the user such as downloading music, pictures and videos.

In another example embodiment, if the activating information includes a self-checking bit which is used, with a verifying algorithm prestored in the vehicle-mounted device, to verify the activating information.

In conclusion, according to the vehicle-mounted device and the method for locally activating the vehicle-mounted device in the first embodiment, the activating process can be locally and directly performed in time to the vehicle-mounted device for acquiring information resources, which is simple, convenient, easy to learn and can bring more convenience to the user.

A second embodiment of the present invention provides a method for remotely activating a vehicle-mounted device of an automobile according to an activating information and by wireless communication connection between the vehicle-mounted device and a data center. The activating information is corresponding to an identity information for indicating an unique identity of the vehicle-mounted device. In an example embodiment, the activating information includes an account and a password which are created previously and having a corresponding relationship with the identity information of the vehicle-mounted device.

FIG. 4 is a flow chart illustrating a method for remotely activating a vehicle-mounted device in the second embodiment.

In the second embodiment, the vehicle-mounted device and the data center both have a wireless communication connection function, and may be directly connected to each other in a wireless communication mode. The structure of the vehicle-mounted device is the same as that in the first embodiment. In the method for remotely activating the vehicle-mounted device of the automobile in the second embodiment, the activating information has a corresponding relationship with the identity information of the vehicle-mounted device. In order to illustrate the method clearly, the activating information is labeled as C21, and a comparison information for verifying the activating information is labeled as C22. The activating information C21 is corresponding to the identity information for indicating the unique identity of the vehicle-mounted device.

The method for remotely activating the vehicle-mounted device of the automobile will be described hereinafter in detail in conjunction with FIG. 4.

A step S20 is performed to store the comparison information C22 which is corresponding to the activating information C21 in a data storage unit of the data center. In an example embodiment, the step S20 may be performed in a production process of the automobile by an automobile producer or in a sale process by a dealer. In another example embodiment, the comparison information C22 may be stored into the data center by a user through a terminal such as a PC, or a cell phone.

Thereafter, a step S21 is performed, in which the activating information C21 is input into the vehicle-mounted device through an input device of the vehicle-mounted device. The activating information C21 is corresponding to an identity information which is stored in the vehicle-mounted device and indicates the unique identity of the vehicle-mounted device. In an example embodiment, the identity information may be serial numbers of the vehicle-mounted device.

Thereafter, a step S22 is performed, in which a communication device is started to communicate with external devices.

Thereafter, a step S23 is performed, in which a processing device of the vehicle-mounted device sends the activating information C21 which is input through the input device to the data center when the communication device is connected to a network.

Thereafter, a step S24 is performed, in which a data processing unit of the data center verifies the activating information C21 according to the prestored comparison information C22 and provides a feedback information. The feedback information will be sent to the vehicle-mounted device, in other words, the processing device of vehicle-mounted device will receive the feedback information when the communication device is connected to a network.

Thereafter, a step S25 is performed, in which a corresponding operation is performed by the vehicle-mounted device according to the feedback information. Specifically, if the activating information C21 matches with the comparison information C22, the feedback information is an activating information for the vehicle-mounted device, and the feedback information is sent to the vehicle-mounted device through a service platform from the data center, in other words, the processing device of the vehicle-mounted device receives the feedback information when the communication device is connected to a network and activates the vehicle-mounted device. In contrast, if the activating information C21 does not match with the comparison information C22, the feedback information is an invalid information, and the feedback information is sent to the vehicle-mounted device through the service platform from the data center, in other words, the processing device of the vehicle-mounted device receives the feedback information when the communication device is connected to a network and does not activate the vehicle-mounted device.

It should be noted that, in another example embodiment, the activating information includes an account and a password (the account and password are corresponding to the identity information of the vehicle-mounted device), which is similar to the embodiment described above, in which the activating information is corresponding to the identity information which is stored in the vehicle-mounted device and indicates the unique identity of the vehicle-mounted device, and will not described in detail herein.

The second embodiment further provides a vehicle-mounted device of an automobile, and the vehicle-mounted device includes: A communication device, adapted for communicating with a service platform of a data center; an input device, adapted for receiving information, wherein the information includes an activating information; and a processing device, adapted for processing the received information and sending out the activating information by the communication device. The processing device includes: An activating information acquiring unit, adapted for acquiring the activating information from the input device when the activating process is triggered; an activating information processing unit, adapted for processing the activating information, sending out the activating information by the communication device, and configuring the vehicle-mounted device in an activated state according to the feedback information from the data center; and application subunits, adapted for responding to requirements of a user.

In addition, the processing device further includes a triggering signal processing device which is adapted for triggering the activating process when the automobile or the vehicle-mounted device is started, or an activating operation is received from the user, and includes an automatic starting device which is adapted for automatically starting the vehicle-mounted device when the automobile is started.

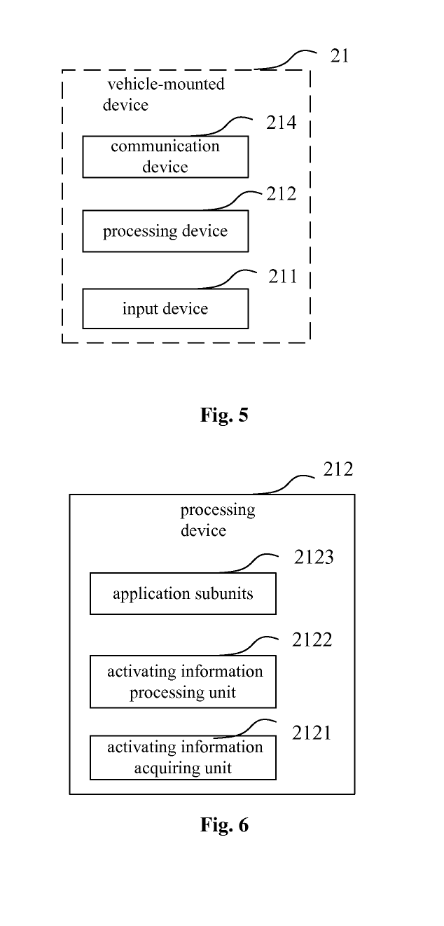

FIG. 5 is a schematic view illustrating a structure of a vehicle-mounted device in the second embodiment, and FIG. 6 is a schematic view illustrating a structure of a processing device of a vehicle-mounted device in the second embodiment. The vehicle-mounted device provided by the second embodiment will be described in detail hereinafter in conjunction with FIG. 5 and FIG. 6.

In the second embodiment, the vehicle-mounted device receives the activating information C21 which indicates the unique identity of the vehicle-mounted device. Referring to FIG. 5, in the second embodiment, the vehicle-mounted device includes: An input device 211 for inputting information; a communication device 214 for data communication with external devices; and a processing device 212 for processing the information which sends and receives data when the communication device 214 is connected to a network. Moreover, the vehicle-mounted device includes a display device with a display function.

Furthermore, the vehicle-mounted device further includes a triggering signal processing device which is adapted for triggering the activating process when the automobile or the vehicle-mounted device is started, or an activating operation is received from the user.

In an example embodiment, a touch-screen display with both inputting function and displaying function is used as the input device 211, which not only can be used to input operation information by the user, but also can be used to play music and display e-books. Moreover, referring to FIG. 6, the processing device 212 includes: An activating information acquiring unit 2121; an activating information processing unit 2122; and application subunits 2123. Because the processing device 212 has functions such as acquiring the activating information, providing corresponding operations according to the activating information and downloading music, the processing device 112 is preferably configured to be a device with a reliable processing performance and a fast processing speed. In addition, the communication device 214 preferably configured to be a device with a wireless communication function. Because the automobile is movable, if the automobile is kept connected to a network and acquiring information resources from the network when it is moving, more convenience will be brought to the user. In an example embodiment, the communication device may include a wireless network card such as CDMA2000 and WCDMA. In other words, the communication device 214 is preferably configured to be a device with a reliable wireless connection and a fast processing speed.

In conclusion, compared to the vehicle-mounted device in the prior art, the vehicle-mounted device in the second embodiment can communicate with external devices by the method for activating the vehicle-mounted device in the second embodiment, and can directly acquire information resources such as music, videos, and e-books from a wireless communication network. Compared to the method for acquiring information resources by downloading from a computer, or from a video compact disc (VCD), or a compact disc (CD), the method for acquiring information resources in the second embodiment is more convenient and simple.

The second embodiment also provides a vehicle-mounted system, and the vehicle-mounted system includes: A vehicle-mounted device, a data center, and a service platform. The service platform is adapted for receiving an activating information and send the activating information to the data center. The data center includes a data storage unit and a data processing unit which can verify the activating information according to a comparison information prestored in the data storage unit. In addition, the vehicle-mounted system further includes application subunits which provide extended functions such as downloading music, listening radio, and reading e-books.

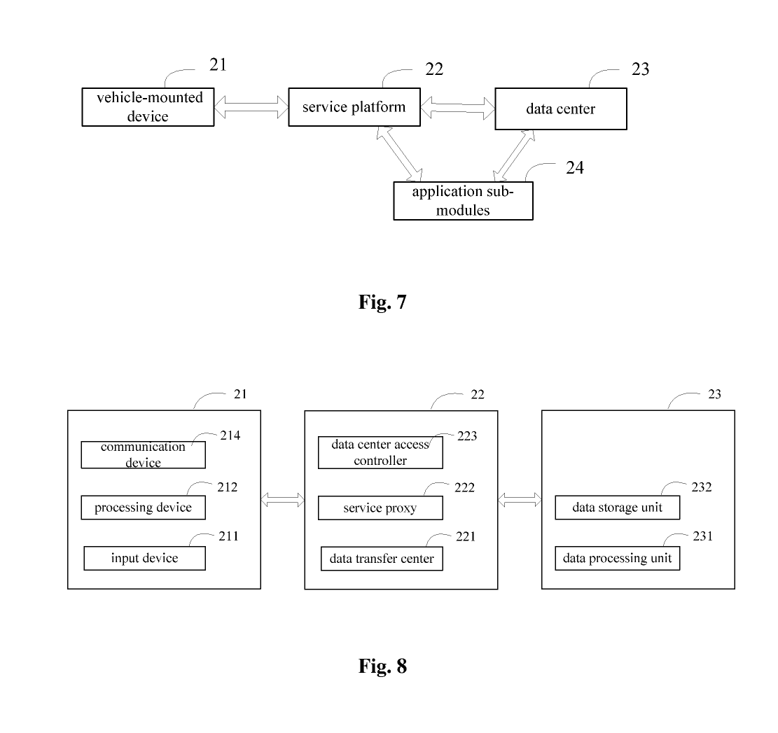

FIG. 7 is a schematic view illustrating a structure of a vehicle-mounted system according to the second embodiment, and FIG. 8 is a schematic view illustrating main units of devices in a vehicle-mounted system according to the second embodiment. In FIG. 8, arrows indicate information flows between different devices of the vehicle-mounted system.

Referring to FIG. 7, the vehicle-mounted system includes: A vehicle-mounted device 21, a service platform 22, a data center 23 and application sub-modules 24. The vehicle-mounted device 22 receives the activating information C21 which is corresponding to the identity information indicating the unique identity of the vehicle-mounted device. In the second embodiment, the vehicle-mounted device 21 is activated according to the activating information C21.

In the second embodiment, referring to the FIG. 8, the vehicle-mounted device 21 includes: An input device 211 for inputting information; a processing device 212 for processing the information; and a communication device 214 for data communication with external devices; and a display device with a displaying function. Moreover, the processing device 212 sends and receives data when the communication device 224 is connected to a network.

In an example embodiment, a touch-screen display with both inputting function and displaying function is used as the input device 211, which not only can be used to input operation information by the user, but also can be used to play music and display e-books. Moreover, referring to FIG. 6, the processing device 212 includes: An activating information acquiring unit 2121; an activating information processing unit 2122; and application subunits 2123. Because the processing device 212 has functions such as acquiring the activating information, providing corresponding operations according to the activating information and downloading music, the processing device 112 is preferably configured to be a device with a reliable processing performance and a fast processing speed. In addition, the communication device 214 preferably configured to be a device with wireless communication function. Because the automobile is movable, if the automobile is kept connected to a network and acquiring information resources from the network when it is moving, more convenience will be brought to the user. In an example embodiment, the communication device may include a wireless network card such as CDMA2000 and WCDMA. In other words, the communication device 214 is preferably configured to be a device with a reliable wireless connection and a fast processing speed.

Furthermore, the vehicle-mounted device further includes a triggering signal processing device which is adapted for triggering the activating process when the automobile or the vehicle-mounted device is started, or an activating operation is received from the user.

In the second embodiment, referring to FIG. 8, the service platform 12 is a platform with multiple functions, which includes: A data transfer center 221, a service proxy 222, and a data center access controller 223. The data transfer center 221 has a function for sending data, the service proxy 222 may call the application sub-modules 24 to perform functions of the application sub-modules 24, and the data center access controller 223 may control access permission to the data center.

Referring to FIG. 8, the data center 23 includes a data processing unit 231 and a data storage unit 232. The data processing unit 231 is adapted for processing data, the data storage unit 232 is adapted for storing data such as the comparison information for verifying the activating information, music and e-books.

Referring to FIGS. 7 and 8, a method for remotely activating the vehicle-mounted device is taken as an example to illustrate a data communication process and a data processing process of a vehicle-mounted system having the vehicle-mounted device according to the second embodiment in detail hereinafter.

In the vehicle-mounted system of the second embodiment, the comparison information C22 is stored in the data storage unit 232 of the data center 23. When the activating information C21 is received by the data center 23, the data processing unit 231 verifies the activating information C21 according to the comparison information C22 and then provides the feedback information.

In the second embodiment, when the vehicle-mounted device 21 is started, the vehicle-mounted device 21 is connected to a wireless network by the communication device. The activating information C21 is input into the vehicle-mounted device through the input device 211, and then the activating information C21 is sent to the service platform 22 by the processing device 212 when the communication device is connected to a network.

Thereafter, the data transfer center 221 of the service platform 22 sends the activating information C21 to the data center 23. The data processing unit 231 of the data center 23 verifies the activating information C21 according to the comparison information C22 and provides the feedback information. The feedback information is sent to the vehicle-mounted device 21, and then the processing device 212 of the vehicle-mounted device 21 receives the feedback information when the communication device is connected to a network. If the activating information C21 matches with the comparison information C22, the feedback information is the activating information for the vehicle-mounted device, and the feedback information is sent to the vehicle-mounted device through a service platform from the data center. In other words, the processing device 212 of the vehicle-mounted device 21 receives the feedback information when the communication device 214 is connected to a network and activates the vehicle-mounted device 21, so that application subunits 2123 may work. In contrast, if the activating information C21 does not match with the comparison information C22, the feedback information is an invalid information, and the feedback information is sent to the vehicle-mounted device 21 through a service platform 22 from the data center 23. In other words, the processing device 212 of the vehicle-mounted device 21 receives the feedback information when the communication device 214 is connected to a network and does not activate the vehicle-mounted device 21, so that the application subunits 2123 do not work.

FIG. 7 further illustrates how the vehicle-mounted device of the vehicle-mounted system acquires information resources in the second embodiment. In the second embodiment, the application sub-modules 24 of the vehicle-mounted device 21 may provide extended functions such as downloading music, receiving radio signals and displaying e-books. The vehicle-mounted device acquires information resources such as music and e-books through the application sub-modules 24.

The extended functions in the second embodiment will be described hereinafter in detail in conjunction with FIGS. 7 and 8.

In the second embodiment, when the vehicle-mounted device 21 is started, the vehicle-mounted device 21 will be connected to a wireless network by the communication device. After information is input into the vehicle-mounted device through the input device 211 by a user, the information is sent to the service platform 22 by the processing device 212 when the communication device is connected to a network.

If the input information is a data request information for requesting the application sub-modules 24 to provide data such as music and e-books, the service platform will operate according to the data request information. In an example embodiment, a data request information for requesting the application sub-modules 24 to provide data such as music and e-books is input into the vehicle-mounted device, the processing device 212 sends the data request information to the service platform 22 when the communication device 214 of the vehicle-mounted device 21 is connected to a network, the service platform 22 transfers the data request information to the application sub-modules 24 by the service proxy 222 for requesting the application sub-modules 24 to provide data such as music and e-books.

Thereafter, the application sub-modules 24 send an access request information to the data center access controller 223 of the data center 22, and the data center access controller 223 checks the access request information sent by the application sub-modules 24. If the access request information meets the access, the application sub-modules 24 will be allowed to access the data center 23.

Thereafter, the application sub-modules 24 may access the data center 23 through the data center access controller 223. specifically, the application sub-modules 24 sends the data request information for requesting data such as music and e-books to the data processing unit 231 of the data center 23 through the data center access controller 223, the data processing unit 231 provides the data such as music and e-books which are stored in the data storage unit 232 according to the data request information, the data such as music and e-books is sent to the application sub-modules by the data center access controller 223, and then the data is sent to the vehicle-mounted device 21 through the service platform 22. In other words, the processing device 212 of the vehicle-mounted device 21 receives the data such as music and e-books when the communication device 214 is connected to a network, and the touch-screen display with both an inputting function and a displaying function serving as the inputting device 211 can play the music and display the e-books according the requirements of the user.

In light of the above description, instead of acquiring information resources such as music, videos and e-books by downloading from a computer, or from a video compact disc (VCD), or a compact disc (CD), the vehicle-mounted system in the embodiments can obtain information resources such as music, videos and e-books in an area covered by a wireless network, which is more easy, practical and convenient.

Although the present invention has been disclosed as above with reference to preferred embodiments, it is not intended to limit the present invention. Those skilled in the art may modify and vary the embodiments without departing from the spirit and scope of the present invention. Accordingly, the scope of the present invention shall be defined in the appended claim.

1. A method for locally activating a vehicle-mounted device of an automobile, comprising:
receiving an activating information after an activating process is triggered; and
verifying the received activating information according to a comparison information locally prestored in the vehicle-mounted device, wherein the vehicle-mounted device is configured in an activated state if the verification is successful.

2. The method according to claim 1, wherein the activating process is triggered when the automobile or the vehicle-mounted device is started, or when an activating operation is received from a user.

3. The method according to claim 1, wherein the vehicle-mounted device receives the activating information from an interface which is used for acquiring the activating information and provided by the vehicle-mounted device.

4. The method according to claim 1, wherein the activating information is corresponding to an identity information of the vehicle-mounted device.

5. The method according to claim 1, wherein the activating information comprises a self-checking bit which is used, with a verifying algorithm stored in the vehicle-mounted device, to verify the activating information.

6. A vehicle-mounted device of an automobile, comprising:
an input device, adapted for receiving information, wherein the information comprises an activating information; and
a processing device, adapted for processing the received information, verifying the activating information and configuring the vehicle-mounted device in an activated state if the verification is successful.

7. The device according to claim 6, wherein the processing device comprises:
an activating information acquiring unit, adapted for acquiring the activating information from the input device when an activating process is triggered; and
an activating information processing unit, adapted for verifying the activating information and configuring the vehicle-mounted device in an activated state if the verification is successful.

8. The device according to claim 6, further comprising: a triggering signal processing device, adapted for triggering the activating process when the automobile or the vehicle-mounted device is started, or an activating operation is received from a user.

9. The device according to claim 6, further comprising: an automatic starting device, adapted for automatically starting the vehicle-mounted device when the automobile is started.

10. A method for remotely activating a vehicle-mounted device of an automobile, comprising:
receiving an activating information;
sending the received activating information from a service platform to a data center;
verifying the activating information by the data center according to a comparison information prestored in the data center and providing a feedback information for activating the vehicle-mounted device if the verification is successful; and
sending the feedback information to the vehicle-mounted device through the service platform.

11. The method according to claim 10, wherein the activating process is trigged when the automobile or the vehicle-mounted device is started, or when an activating operation is received from a user.

12. The method according to claim 10, wherein the vehicle-mounted device receives the activating information from an interface which is used for acquiring the activating information and provided by the vehicle-mounted device.

13. The method according to claim 10, wherein the activating information is corresponding to an identity information of the vehicle-mounted device.

14. The method according to claim 10, wherein the activating information comprises an account and a password which are created previously.

15. The method according to claim 14, wherein the account and the password, created previously as the activating information, have a corresponding relationship with the identity information of the vehicle-mounted device.

16. A vehicle-mounted device of an automobile, comprising:
a communication device, adapted for data intercommunication between the vehicle-mounted device and a service platform;
an input device, adapted for receiving information, wherein the information comprises an activating information; and
a processing device, adapted for processing the received information and sending out the activating information by the communication device.

17. The device according to claim 16, wherein the processing device comprises:
an activating information acquiring unit, adapted for acquiring the activating information from the input device when the activating process is triggered; and
an activating information processing unit, adapted for processing the activating information, sending out the activating information through the communication device, and configuring the vehicle-mounted device in an activated state according to an feedback information from the data center.

18. The device according to claim 16, further comprising: a triggering signal processing device, adapted for triggering the activating process when the automobile or the vehicle-mounted device is started, or an activating operation is received from a user.

19. The device according to claim 16, further comprising: an automatic starting device, adapted for automatically starting the vehicle-mounted device when an automobile is started.

20. A vehicle-mounted system of an automobile, comprising:
a vehicle-mounted device, a data center, and a service platform,
wherein the platform is adapted for receiving an activating information from the vehicle-mounted device and sending the activating information to the data center,
and wherein the data center comprises a data storage unit and a data processing unit which is adapted for verifying the activating information according to a comparison information prestored in the data storage unit and providing an feedback information for activating the vehicle-mounted device.

21. The system according to claim 20, wherein the vehicle-mounted device comprises:
a communication device, adapted for data intercommunication between the vehicle-mounted device and a service platform;
an input device, adapted for receiving information, wherein the information comprises an activating information; and
a processing device, adapted for processing the received information and sending out the activating information by the communication device.

22. The system according to claim 21, wherein the processing device comprises:
an activating information acquiring unit, adapted for acquiring the activating information from the input device when the activating process is triggered; and
an activating information processing unit, adapted for processing the activating information, sending out the activating information by the communication device, and configuring the vehicle-mounted device in an activated state according to the feedback information from the data center.

23. The system according to claim 22, wherein the processing device further comprises: application subunits which are adopted to response service requirements from a user.

24. The system according to claim 21, wherein the vehicle-mounted device comprises a triggering signal processing device, adapted for triggering the activating process when the automobile or the vehicle-mounted device is started, or an activating operation is received from a user.
